(19) United States
(12) Patent Application Publication
(10) Pub. No.: US 2025/0149829 A1
(43) Pub. Date: May 8, 2025

(54) CONNECTOR

(71) Applicant: SUMITOMO WIRING SYSTEMS, LTD., Mie (JP)

(72) Inventor: Kazumi OKA, Mie (JP)

(21) Appl. No.: 18/837,890

(22) PCT Filed: Jan. 30, 2023
(86) PCT No.: PCT/JP2023/002851

§ 371 Date: Aug. 13, 2024

(30) Foreign Application Priority Data
Feb. 14, 2022 (JP) 2022-020221

(51) Int. Cl. H01R 13/641; H01R 13/631

(52) U.S. Cl. CPC H01R 13/641; H01R 13/631

(57) ABSTRACT

A moving plate (13) is arranged movably with respect to a housing (11) between an initial position and a connection position rearward of the initial position in a receptacle (15). The moving plate (13) includes a plate body (33) for surrounding a tab (19) of a male terminal (12) in the receptacle (15) and a projecting portion (48) projecting rearward from the plate body (33). The housing (11) includes a through hole (27), through which the projecting portion (28) is passed. The projecting portion (48) is maintained in a state unlocked to the housing (11) and a rear end part thereof is exposed rearward from the through hole (27) at least at the connection position.

### TECHNICAL FIELD

The present disclosure relates to a connector.

### BACKGROUND

Patent Document 1 discloses a connector in which a terminal fitting insertion detecting member (hereinafter, referred to as a moving plate) is accommodated movably in a receptacle. The moving plate includes a flexibly deforming frame portion arranged on a side surface of a housing body. The flexibly deforming frame portion includes a temporary locking projection and a complete locking projection. The temporary locking projection and the complete locking projection are locked to the side surface of the housing body, whereby the moving plate is held at a temporary locking position and a complete locking position with respect to the housing body. Connectors provided with a moving plate are also disclosed in Patent Documents 2 to 4.

### PRIOR ART DOCUMENT

### Patent Document

Patent Document 1: JP H11-086950 A
Patent Document 2: JP 2003-317870 A
Patent Document 3: JP 2006-331925 A
Patent Document 4: JP 2016-213084 A

### SUMMARY OF THE INVENTION

### Problems to be Solved

A moving plate normally includes positioning holes, through which tabs of male terminals are passed while being positioned in a receptacle, and functions to protect the tabs. If the moving plate is inclined in a moving process, the tabs may interfere with the inner surfaces of the positioning holes to be deformed, which is not preferable. In that respect, since the flexibly deforming frame portion is exposed on the side surface of the housing body in the case of Patent Document 1, whether or not the moving plate is inclined can be confirmed by visually confirming a state change (posture change) of the flexibly deforming frame portion. However, since the flexibly deforming frame portion includes the temporary locking projection and the complete locking projection to be locked to the housing body, it is difficult to confirm the state change. Further, since the flexibly deforming frame portion itself is also deflected and deformed during a movement of the moving plate, there is a problem that the detection of the state of the moving plate lacks reliability.

Accordingly, the present disclosure aims to provide a connector capable of improving reliability in detecting a state of a moving plate.

### Means to Solve the Problem

The present disclosure is directed to a connector with a housing including a receptacle, a male terminal including a tab projecting into the receptacle, and a moving plate arranged movably with respect to the housing between an initial position and a connection position rearward of the initial position in the receptacle, the moving plate including a plate body for surrounding the tab of the male terminal in the receptacle and a projecting portion projecting rearward from the plate body, the housing including a through hole, the projecting portion being passed through the through hole, and the projecting portion being maintained in a state unlocked to the housing and a rear end part thereof being exposed rearward from the through hole at least at the connection position.

### Effect of the Invention

According to the present disclosure, it is possible to provide a connector capable of improving reliability in detecting a state of a moving plate.

### BRIEF DESCRIPTION OF THE DRAWINGS

FIG. 1 is a front view of a connector when a moving plate is at an initial position in one embodiment of the present disclosure.

FIG. 2 is a section along A-A of FIG. 1.

FIG. 3 is a side view in section of the connector connected to a mating connector.

FIG. 4 is a perspective view of a mating housing when viewed obliquely from a front upper side.

FIG. 5 is a front view of a housing.

FIG. 6 is a back view of the housing.

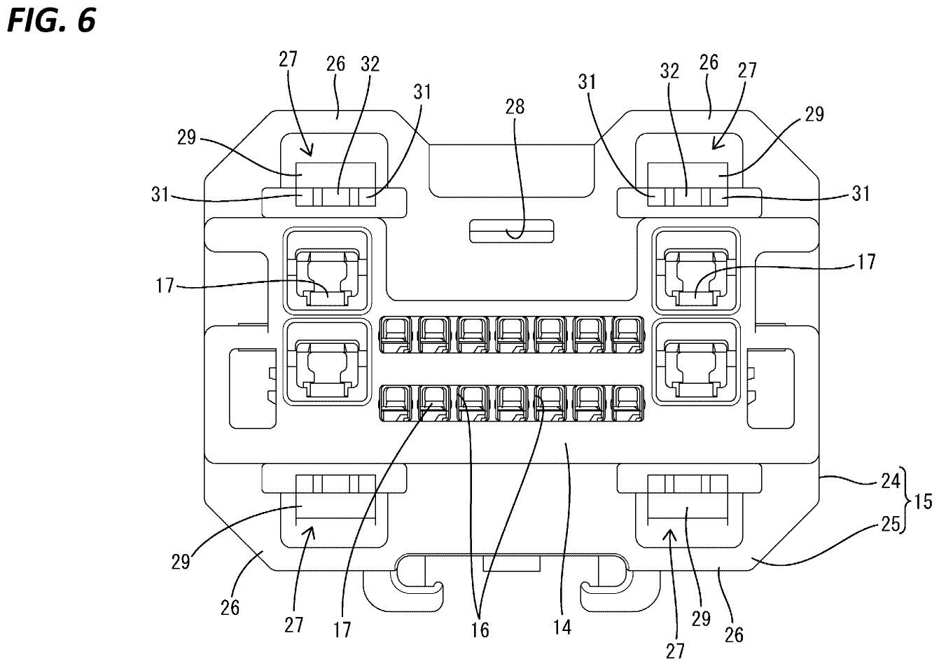

FIG. 7 is a partial enlarged perspective view of a resilient locking portion when viewed obliquely from a front lower side.

FIG. 8 is a perspective view of the moving plate when viewed obliquely from the front upper side.

FIG. 9 is a perspective view of the moving plate when viewed obliquely from a rear upper side.

FIG. 10 is a perspective view of the connector when the moving plate is at a connection position when viewed obliquely from the rear upper side.

FIG. 11 is a partial enlarged section showing a state where a plate engaging portion of the mating housing is engaged with an engaging portion of the moving plate.

FIG. 12 is a partial enlarged section showing a state where a jig is hooked to a hooking portion of the moving plate when the moving plate is at the initial position.

FIG. 13 is a partial enlarged section showing a state where a locking lance is deflected and deformed by an unlocking jig when the moving plate is at the connection position.

FIG. 14 is a plan view of the connector when the moving plate is at the initial position.

FIG. 15 is a plan view of the connector when the moving plate is at the connection position.

FIG. 16 is a plan view of the connector when the moving plate is in an inclined state in a moving process.

### DETAILED DESCRIPTION TO EXECUTE THE INVENTION

### Description of Embodiments of Present Disclosure

### First, Embodiments of the Present Disclosure are Listed and Described

(1) The connector of the present disclosure is provided with a housing including a receptacle, a male terminal including a tab projecting into the receptacle, and a moving plate arranged movably with respect to the housing between an initial position and a connection position rearward of the initial position in the receptacle, the moving plate including a plate body for surrounding the tab of the male terminal in the receptacle and a projecting portion projecting rearward from the plate body, the housing including a through hole, the projecting portion being passed through the through hole, and the projecting portion being maintained in a state unlocked to the housing and a rear end part thereof being exposed rearward from the through hole at least at the connection position.

When the moving plate moves from the initial position to the connection position, a projection amount of the projecting portion from the through hole increases. In contrast, when the moving plate moves from the connection position to the initial position, the projection amount of the projecting portion from the through hole decreases. A worker can detect a movement amount of the moving plate from the connection position by visually confirming the projection amount of the projecting portion from the through hole and can detect whether or not the moving plate is inclined from a proper posture by visually confirming a state (posture) of the projecting portion. Particularly, since the projecting portion is maintained in the state unlocked to the housing, the projecting portion can be prevented from undergoing deflection, deformation or the like due to interference with the housing and the visibility of the projecting portion is excellent. As a result, reliability in detecting a state of the moving plate can be improved.

(2) The rear end part of the projecting portion may be arranged in the through hole at the initial position.

According to the above configuration, it is understood that the moving plate is not arranged at the initial position in a state where the projecting portion is seen from outside.

(3) The housing may include a housing body behind the receptacle, the housing body accommodating the male terminal, and the rear end part of the projecting portion may be arranged along an outer surface of the housing body at the connection position. According to the above configuration, since the projecting portion is protected by the housing body, the breakage and damage thereof can be avoided.

(4) A plurality of the projecting portions may be formed side by side behind the plate body.

According to the above configuration, even in a situation where any one of the plurality of projecting portions cannot be visually confirmed, the worker can detect the state of the moving plate by visually confirming the remaining projecting portion(s). In a situation where the plurality of projecting portions can be visually confirmed, the worker can more accurately detect the state of the moving plate based on a positional relationship of the respective projecting portions and a positional relationship of the respective projecting portions and the housing.

(5) The projecting portion may include a hooking portion projecting in a direction intersecting a front-rear direction from the rear end part of the projecting portion. In pulling out the male terminal from the cavity of the housing, the moving plate may be moved from the initial position to the connection position in advance. According to the above configuration, the projecting portion can be pulled out from the through hole and the moving plate can be brought to the connection position by hooking a jig to the hooking portion and pulling the jig rearward. Unlike a case where the plate body is pushed from front by a jig to bring the moving plate to the connection position, a possibility that the jig interferes with the tab of the male terminal is low and the breakage and damage of the tab can be prevented in the case of the above configuration.

(6) The housing may include a deflectable and deformable resilient locking portion projecting rearward, and a rear end part of the resilient locking portion may include a locking projection adjacent to the hooking portion to lock the plate body when the moving plate is at the initial position.

According to the above configuration, a force for releasing locking with the plate body can be efficiently transferred to the locking projection by hooking the jig to the hooking portion and pulling the jig rearward. Thus, the resilient locking portion can be deflected and deformed and the locking of the locking projection and the plate body can be released by pulling the jig rearward.

### Details of Embodiment of Present Disclosure

A specific example of the present disclosure is described below with reference to the drawings. Note that the present invention is not limited to this illustration, but is represented by claims and intended to include all changes in the scope of claims and in the meaning and scope of equivalents.

### Embodiment

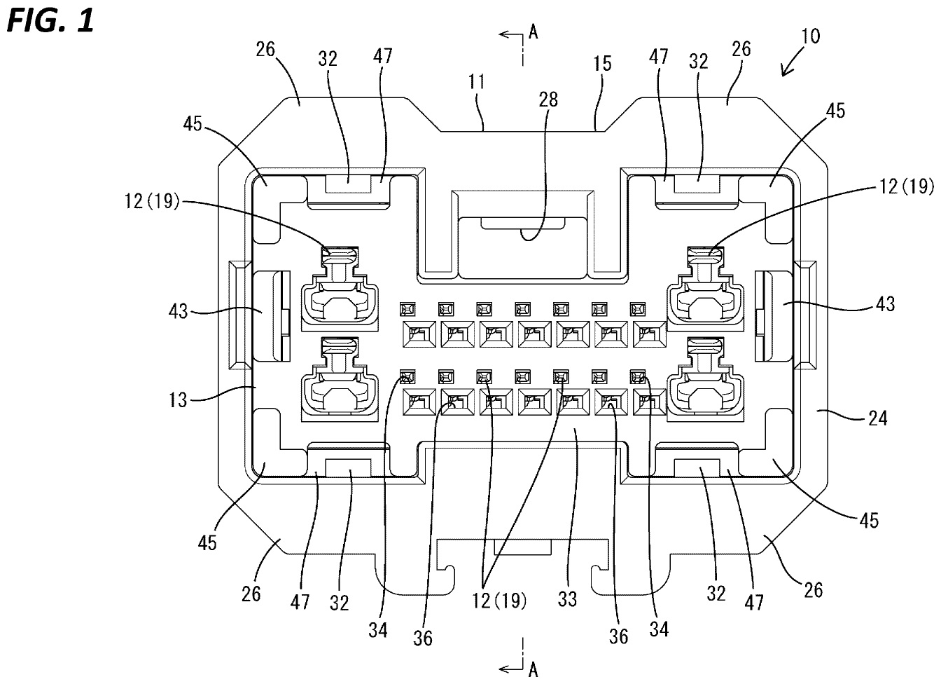

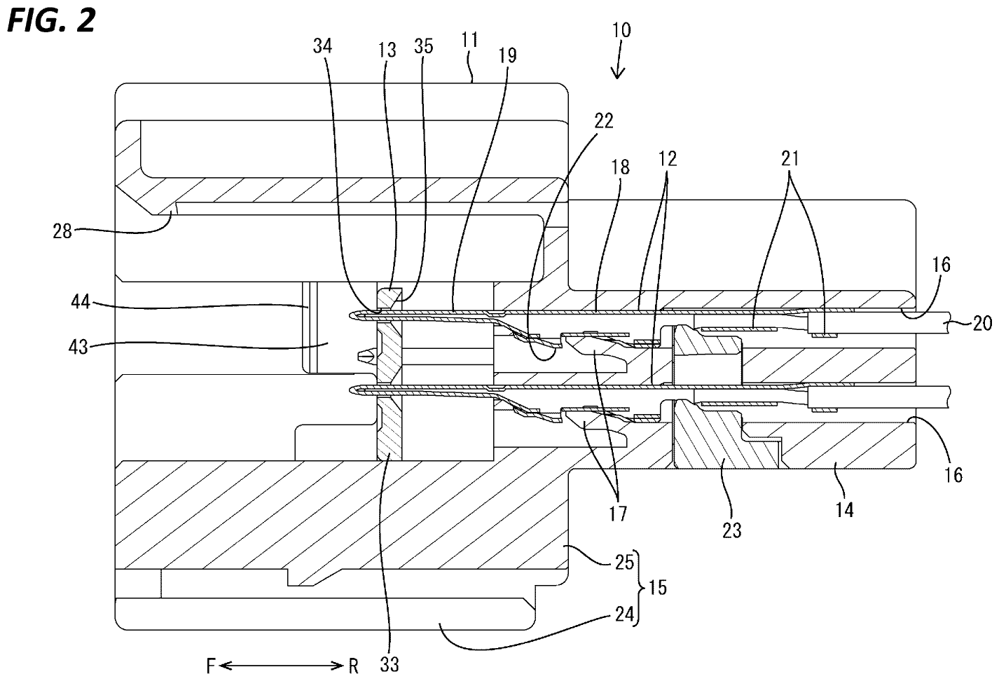

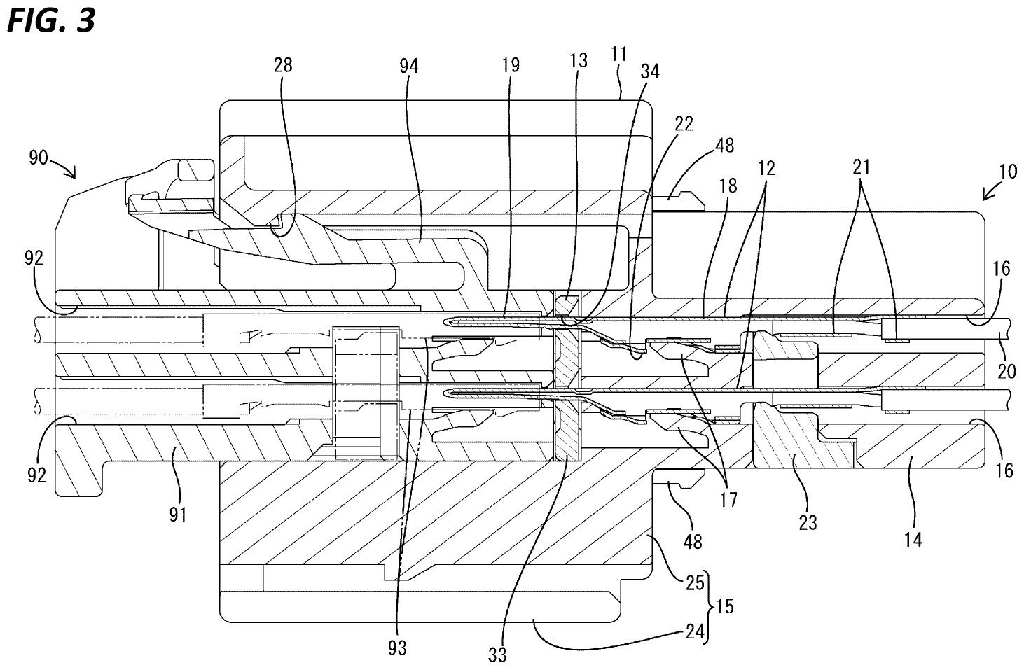

As shown in FIGS. 1 and 2, a connector 10 according to one embodiment of the present disclosure is provided with a housing 11, male terminals 12 to be accommodated into the housing 11 and a moving plate 13 to be assembled with the housing 11 movably between an initial position and a connection position. As shown in FIG. 3, the connector 10 is connected to a mating connector 90. Note that, in the following description, sides of the connector 10 and the mating connector 90 to be connected to each other are referred to as front sides concerning a front-rear direction. In FIGS. 2, 4, 7 and the like, a side indicated by an arrow F is a front side and a side indicated by an arrow R is a rear side. A vertical direction is based on a vertical direction of FIGS. 1 to 3. The vertical direction is synonymous with a height direction. A lateral direction is a direction intersecting the front-rear direction and vertical direction, and synonymous with a width direction.

### (Mating Connector)

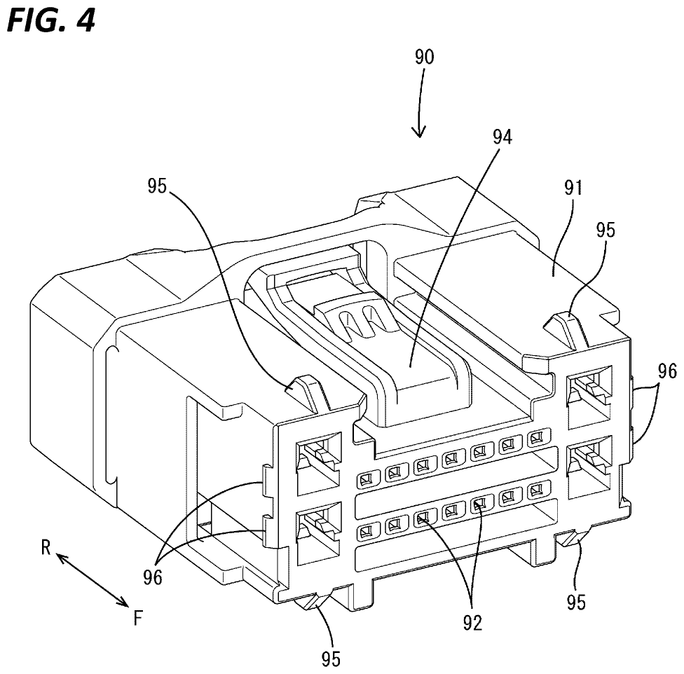

The mating connector 90 is provided with a mating housing 91 made of synthetic resin. As shown in FIGS. 3 and 4, the mating housing 91 includes a plurality of mating cavities 92. As shown in FIG. 3, a female terminal 93 serving as a mating terminal is accommodated in each mating cavity 92. A deflectable and deformable lock arm 94 is formed in a lateral middle part of the upper surface of the mating housing 91. The lock arm 94 has a function of locking the housing 11 and holding the housing 11 and the mating housing 91 in a connected state. As shown in FIG. 4, a pair of releasing portions 95 are formed to project on both left and right sides of a front end part of each of the upper and lower surfaces of the mating housing 91. Each releasing portion 95 has a function of releasing the locking of the moving plate 13 at the initial position and the housing 11. Further, plate engaging portions 96 are respectively formed to project on both left and right side surfaces of the mating housing 91. The respective plate engaging portions 96 are arranged in pair in the height direction on the side surfaces of the mating housing 91. Each plate engaging portion 96 has a function of moving the moving plate 13 from the connection position to be described later to the initial position.

### (Connector)

The housing 11 is made of synthetic resin and includes, as shown in FIG. 2, a housing body 14 and a receptacle 15 projecting forward from the housing body 14. The housing body 14 includes a plurality of cavities 16. A locking lance 17 projecting forward is formed on the lower surface of the inner wall of each cavity 16. The male terminal 12 is accommodated in each cavity 16.

The male terminal 12 is made of electrically conductive metal and includes, as shown in FIG. 2, a tubular body portion 18, a tab 19 projecting forward from the body portion 18 and a barrel portion 21 connected behind the body portion 18 and to be crimped and connected to a wire 20. The tab 19 projects into the receptacle 15. The body portion 18 includes a locking claw 22 to be locked by the locking lance 17 in the cavity 16. The rear end of the body portion 18 is locked by a retainer 23 assembled with the housing body 14. The terminal fitting is primarily restricted from coming out from the cavity 16 by the locking lance 17 and secondarily restricted from coming out from the cavity 16 by the retainer 23.

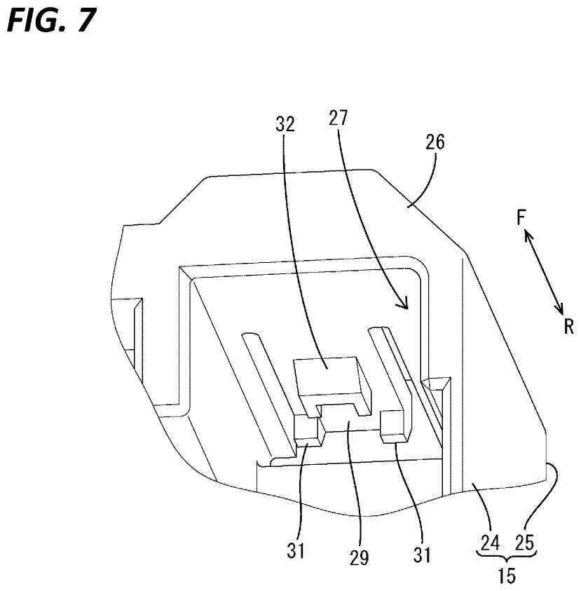

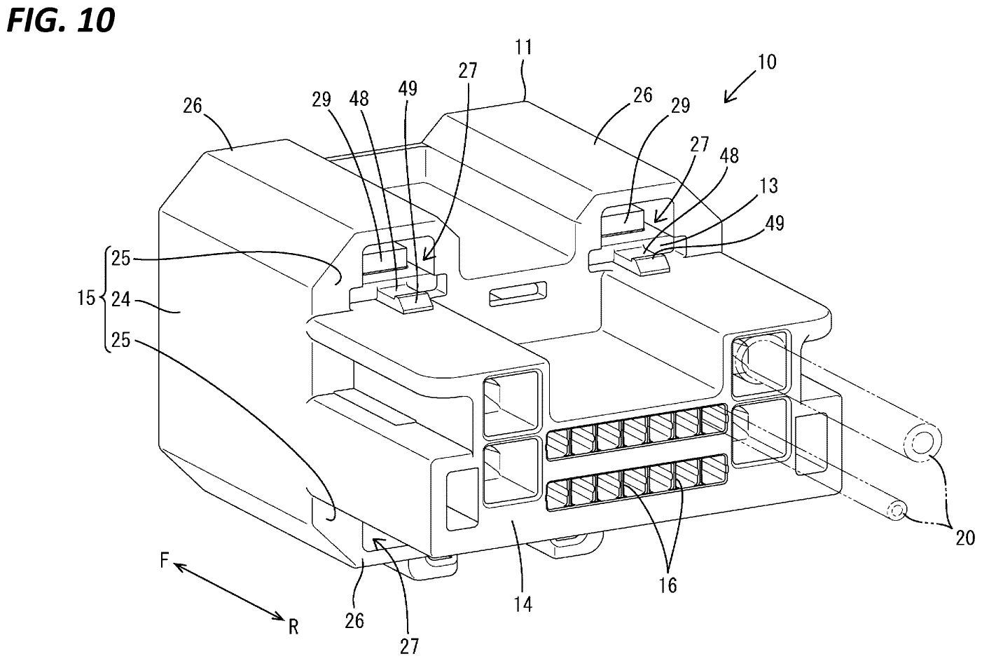

As shown in FIG. 10, the receptacle 15 includes a tubular receptacle body 24 extending in the front-rear direction and step portions 25 protruding upward and downward from the front end of the housing body 14 to the rear end of the receptacle body 24. The respective step portions 25 include tunnel-like bulging portions 26 continuous from the receptacle body 24 on both left and right sides, and a pair of through holes 27 are formed inside each bulging portion 26. Each through hole 27 extends in the front-rear direction in the step portion 25, is open rearward of the step portion 25 and, as shown in FIG. 7, communicates with the inside of the receptacle body 24.

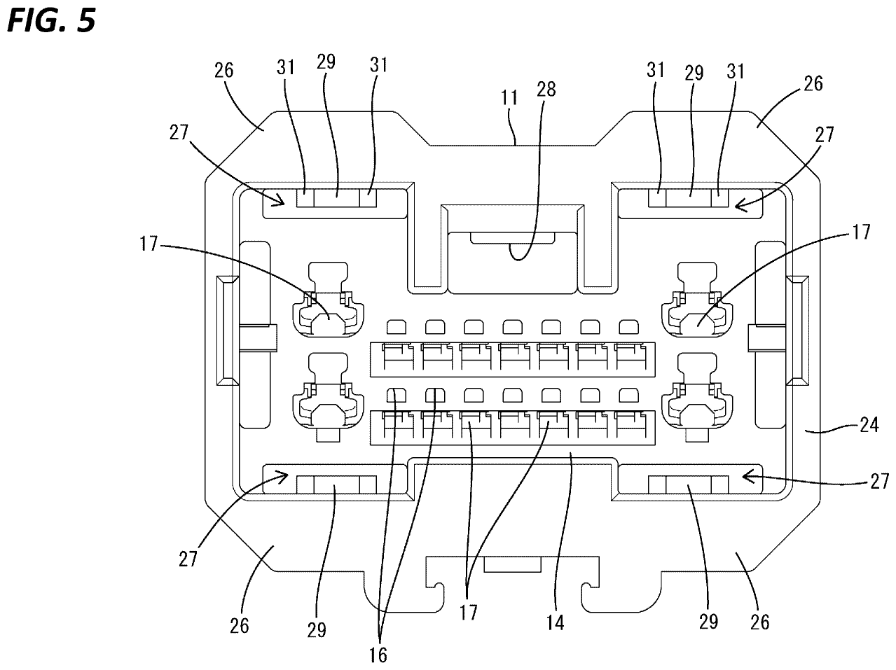

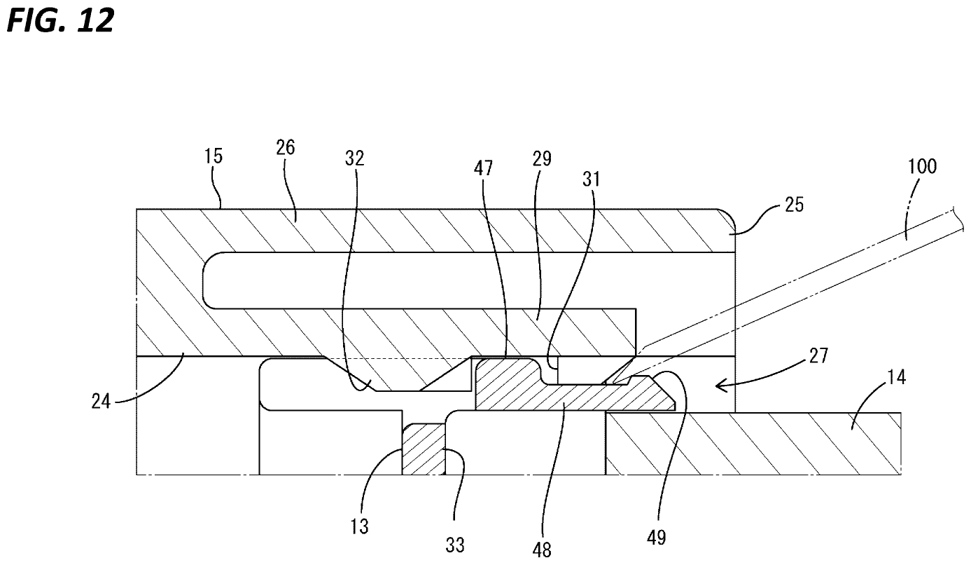

As shown in FIG. 5, the receptacle body 24 is in the form of a rectangular tube and includes a lock portion 28 projecting downward on the front end of a lateral middle part of an upper wall. As shown in FIG. 3, the lock portion 28 is locked to the lock arm 94. Further, as shown in FIGS. 5, 7 and 12, the receptacle body 24 includes a pair of resilient locking portions 29 (only one is shown in FIGS. 7 and 12) cantilevered rearward from middle parts in the front-rear direction on both left and right sides of each of the upper and lower walls. As shown in FIGS. 7 and 12, the resilient locking portion 29 is arranged in the through hole 27. The resilient locking portion 29 includes locking projections 31 projecting inward (side where the housing body 14 is located) from a rear end part. As shown in FIG. 7, the locking projections 31 are arranged laterally at an interval in the rear end part of the resilient locking portion 29. As shown in FIG. 12, the front surface of the locking projection 31 is perpendicularly arranged in the vertical direction. The rear surface of the locking projection 31 is inclined forward toward an inner side (tip side in a projecting direction). The locking projection 31 has a function of restricting a movement of the moving plate 13 from the initial position to the connection position.

As shown in FIGS. 7 and 12, the resilient locking portion 29 includes a complete locking projection 32 projecting inward from the middle part in the front-rear direction. As shown in FIG. 7, the complete locking projection 32 is arranged between the left and right locking projections 31 in the lateral direction behind the locking projections 31. As shown in FIG. 12, the front surface of the complete locking projection 32 is inclined rearward toward the inner side. A lateral middle part of the rear surface of the complete locking projection 32 is inclined forward toward the inner side, and both left and right end parts thereof are perpendicularly arranged in the vertical direction. The complete locking projection 32 has a function of restricting the moving plate 13 at the initial position from coming out forward from the receptacle 15.

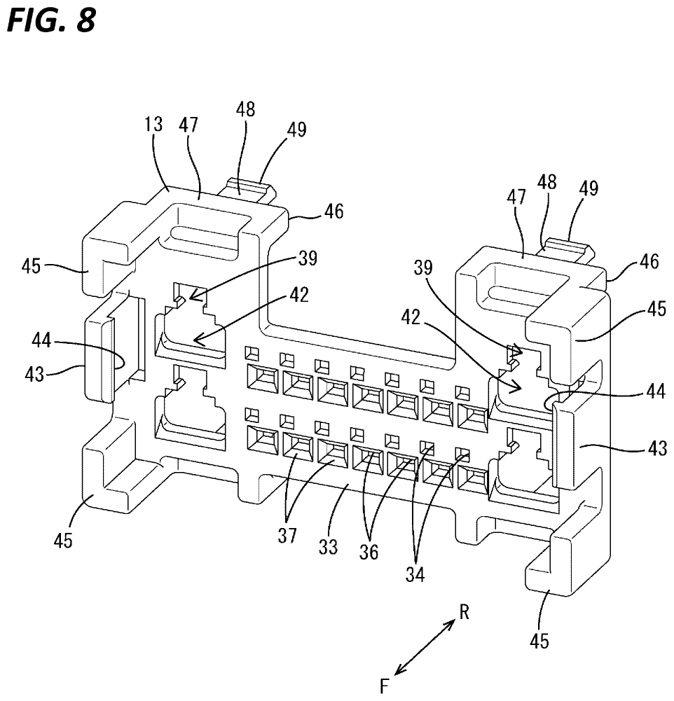

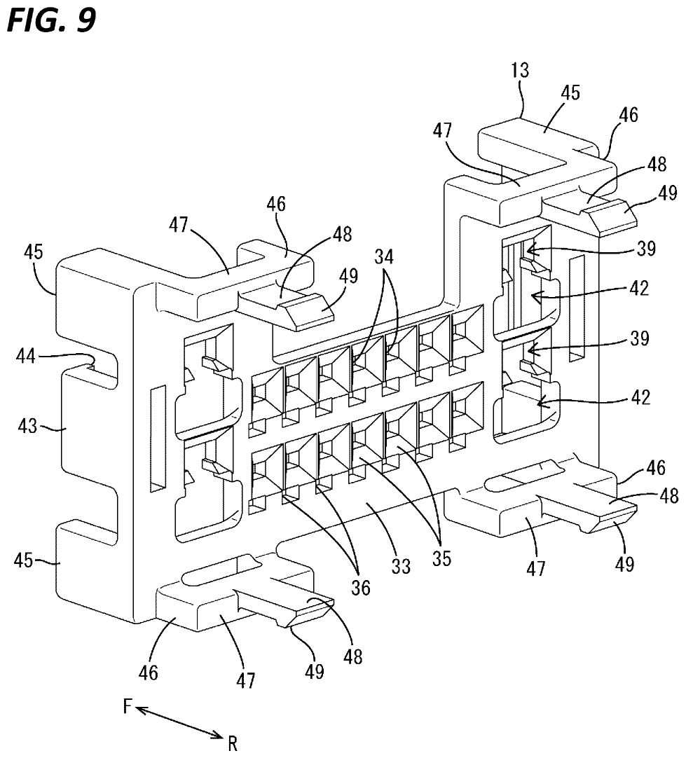

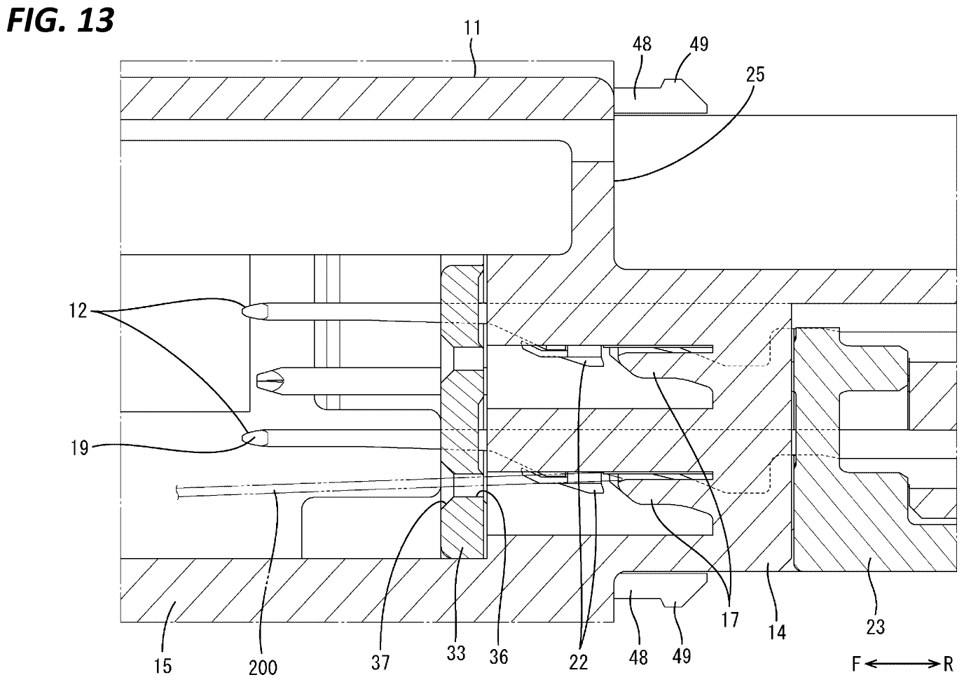

The moving plate 13 is made of synthetic resin and, as shown in FIGS. 8 and 9, provided with a plate-like plate body 33. The plate body 33 is arranged with plate surfaces facing in the front-rear direction. As shown in FIG. 8, the plate body 33 includes a plurality of positioning holes 34 in a lateral middle part. Each positioning hole 34 has a rectangular cross-section and penetrates through the plate body 33 in the front-rear direction. As shown in FIG. 9, a tab guiding portion 35 expanded over an entire periphery is formed in an opening edge part of each positioning hole 34 in the rear surface of the plate body 33. The tab 19 of the male terminal 12 is positioned and inserted into the positioning hole 34 while being guided by the tab guiding portion 35 (see FIG. 2). Further, the plate body 33 includes a plurality of jig insertion holes 36. The respective jig insertion holes 36 have a rectangular cross-section and are arranged below the respective positioning holes 34 to correspond to the positioning holes 34. A jig guiding portion 37 expanded over an entire periphery is formed in an opening edge part of each jig insertion hole 36 in the front surface of the plate body 33. An unlocking jig 200 is inserted into the jig insertion hole 36 while being guided by the jig guiding portion 37, and a tip part thereof can contact the locking lance 17 (see FIG. 13).

As shown in FIGS. 8 and 9, the plate body 33 includes a plurality of large-size positioning holes 39, through which tabs 19 of large-size male terminals 12 are insertable, in end parts on both left and right sides across the respective positioning holes 34. A large-size jig insertion hole 42 for releasing the locking of the large-size locking lance 17 is formed below each large-size positioning hole 39. Each large-size positioning hole 39 communicates with each large-size jig insertion hole 42.

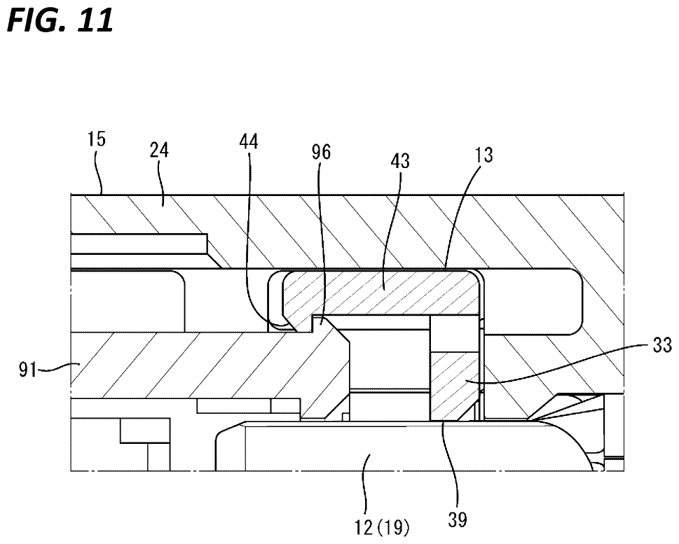

As shown in FIG. 8, the moving plate 13 includes a pair of engaging portions 43 projecting forward from vertical middle parts on the end parts on the both left and right sides of the plate body 33. Each engaging portion 43 is in the form of a rectangular plate and arranged with plate surfaces facing leftward and rightward. Engaging projections 44 are formed to project inward (toward sides facing each other) on the front ends of the respective engaging portions 43. The engaging projection 44 is in the form of a rib extending in the vertical direction on the front end of the engaging portion 43. As shown in FIG. 11, the engaging projection 44 of the engaging portion 43 is engageable in a hooking state with the plate engaging portion 96 of the mating housing 91.

As shown in FIG. 8, the moving plate 13 includes a plurality of guide portions 45 projecting forward from four corner parts of the plate body 33. Each guide portion 45 has an L-shaped cross-section and is formed over two sides defining each of the four corner parts of the plate body 33. The respective guide portions 45 have a function of guiding a moving operation of the moving plate 13 in the receptacle 15 by sliding on the inner surfaces of the four corner parts of the receptacle body 24 (see FIG. 1).

Further, as shown in FIG. 9, the moving plate 13 includes a pair of frame portions 46 protruding rearward from both left and right end parts on each of end parts on both upper and lower sides of the plate body 33. Each frame portion 46 is in the form of a frame rectangular in a plan view and includes a beam-like locked portion 47 along the width direction in a rear end part.

Further, the moving plate 13 includes pairs of projecting portions 48 projecting rearward from lateral middle parts of the locked portions 47 of the respective frame portions 46. Each projecting portion 48 is in the form of a plate rectangular in a plan view and arranged with plate surfaces facing upward and downward. The respective projecting portions 48 include hooking portions 49 projecting outward (separating sides in the vertical direction) on rear end parts. The hooking portion 49 is in the shape of a rib extending in the lateral direction in the rear end part of the projecting portion 48. The front surface of the hooking portion 49 is inclined rearward toward an outer side (tip side in a projecting direction). The rear surface of the hooking portion 49 is inclined forward toward the outer side.

### (Connection and Separation of Connector)

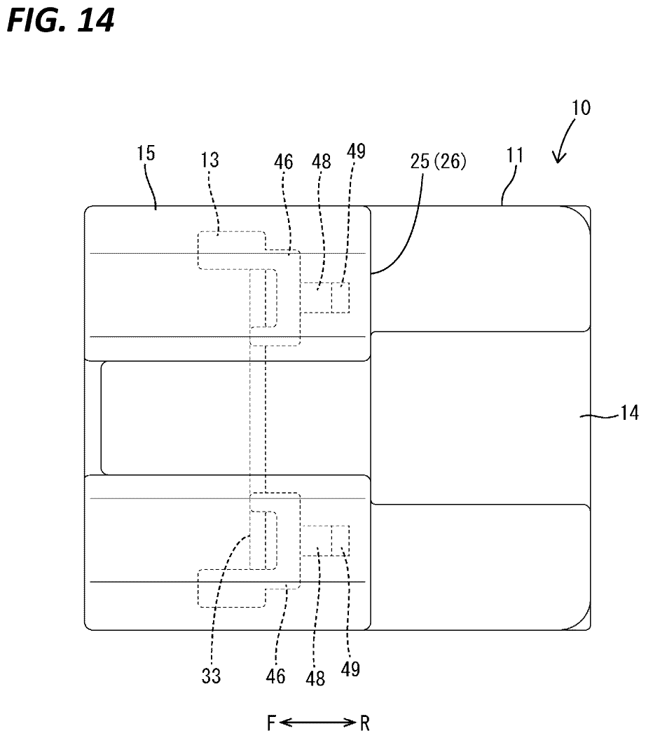

Prior to the connection of the housing 11 and the mating housing 91, the moving plate 13 is mounted into the receptacle 15 of the housing 11 and held at the initial position with respect to the housing 11. As shown in FIG. 2, at the initial position, the plate body 33 is arranged in the receptacle 15, and a front end part of the tab 19 of each male terminal 12 is inserted through each positioning hole 34 of the plate body 33. Further, as shown in FIG. 12, at the initial position, the locked portions 47 of the moving plate 13 are sandwiched in the front-rear direction between the locking projections 31 and the complete locking projections 32 in the resilient locking portions 29 to restrict a movement of the moving plate 13 in the receptacle 15. Further, at the initial position, the projecting portion 48 including the hooking portion 49 on the rear end part is arranged in each through hole 27 of the housing 11. Thus, as shown in FIG. 14, each projecting portion 48 is hidden in the receptacle 15 and cannot be visually confirmed even if the housing 11 is viewed from above.

When the connection of the housing 11 and the mating housing 91 is started, the mating housing 91 is inserted into the receptacle 15. Then, each releasing portion 95 of the mating housing 91 slides on the front surface (front surface when viewed from the side of the connector 10) of the complete locking projection 32 of each resilient locking portion 29, each resilient locking portion 29 is deflected and deformed outward, and the locking of each locking projection 31 and each locked portion 47 is released. In this way, the moving plate 13 becomes movable. As the connection of the connector 10 proceeds, the moving plate 13 is pushed by the mating housing 91 and moved toward the connection position.

When the housing 11 and the mating housing 91 are properly connected, the moving plate 13 can reach the connection position. At the connection position, the plate body 33 is arranged to be sandwiched in the front-rear direction between the housing body 14 and the mating housing 91 on a back end side (rear end side) in the receptacle 15 as shown in FIG. 3. Each male terminal 12 is electrically connected to each female terminal 93 accommodated in the mating housing 91. Further, the lock arm 94 is resiliently locked to the lock portion 28, and the housing 11 and the mating housing 91 are held in the connected state.

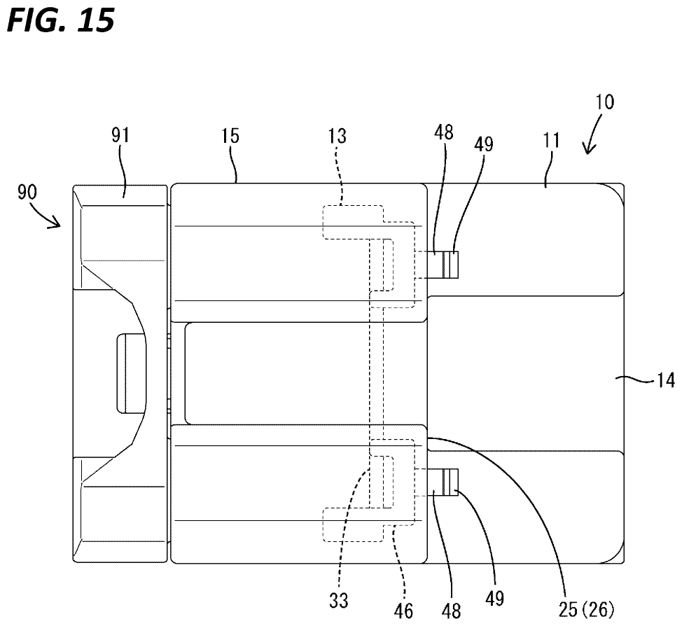

In the process of moving the moving plate 13 from the initial position toward the connection position, the respective projecting portions 48 project rearward from the respective through holes 27 and are arranged to be exposed on the outer surface of the housing body 14. Specifically, the respective projecting portions 48 are arranged along the upper and lower surfaces of the housing body 14 with tiny gaps formed between the projecting portions 48 and the upper and lower surfaces (see FIG. 13). That is, the respective projecting portions 48 are arranged not to contact the outer surface of the housing body 14. A projection amount (exposure amount) of each projecting portion 48 from each through hole 27 gradually increases as the moving plate 13 approaches the connection position. At the connection position, the projection amount of each projecting portion 48 from each through hole 27 has a maximum value and the entire hooking portion 49 of each projecting portion 48 is arranged to be exposed on the outer surface of the housing body 14 (see FIGS. 10 and 15).

Here, two projecting portions 48 are arranged on the upper surface of the housing body 14. Thus, when the connector 10 is viewed from above in a worker's normal viewing direction, states (postures) of the two projecting portions 48 arranged on the upper surface of the housing body 14 can be easily visually confirmed as shown in FIG. 15. Particularly, since each projecting portion 48 has a rectangular shape in a plan view and does not have a complicated shape, visibility is excellent. Here, if the projection amount of the projecting portion 48 from the through hole 27 has not reached the maximum value, it is understood that the moving plate 13 has not reached the connection position yet. In the case of this embodiment, if the moving plate 13 is assembled with the housing 11 in a proper posture, the respective projecting portions 48 and the rear surfaces of the step portions 25 (also the bulging portions 26) are positioned to intersect at a right angle as shown in FIG. 15.

In separating the housing 11 and the mating housing 91 for maintenance or other reason, the locking of the lock arm 94 and the lock portion 28 is released and the mating housing 91 is pulled out from the receptacle 15. In the process of moving the mating housing 91 rearward, the engaging portions 43 are hooked to the plate engaging portions 96 as shown in FIG. 11 and the moving plate 13 is moved from the connection position toward the initial position. When the moving plate 13 reaches the initial position, the locked portions 47 are sandwiched between the locking projections 31 and the complete locking projections 32 of the resilient locking portions 29 and a movement of the moving plate 13 is stopped. Thereafter, the mating housing 91 is pulled out from the receptacle 15 and the housing 11 and the mating housing 91 are separated.

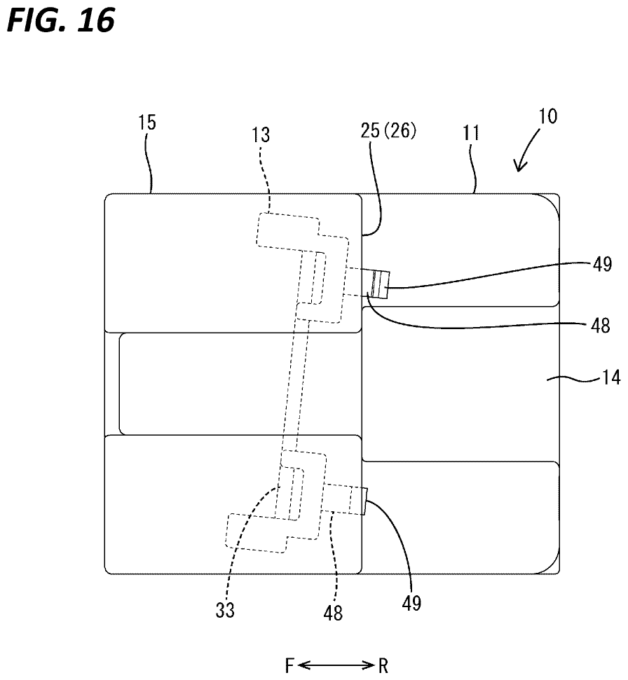

If the plate body 33 is inclined in the receptacle 15 in a separation process of the mating housing 91, the tab 19 of each male terminal 12 interferes with the hole surface of each positioning hole 34 of the plate body 33, which is not preferable. In contrast, in the case of this embodiment, if the plate body 33 is inclined in the receptacle 15, the respective projecting portions 48 are also inclined according to the inclination of the plate body 33, and inclined states of the two projecting portions 48 exposed on the upper surface of the housing body 14 can be visually confirmed from above the housing 11. Specifically, as shown in FIG. 16, each of the two projecting portions 48 is in a posture inclined with respect to the front-rear direction. Further, out of the two projecting portions 48, one projecting portion 48 largely projects rearward from the rear surface of the step portion 25, whereas the other projecting portion 48 projects a little from the rear surface of the step portion 25 or is arranged inside the step portion 25 (in the through hole 27). Thus, by visually confirming the above states of the respective projecting portions 48, it is understood that the moving plate 13 is in the inclined state.

In releasing the locking of the male terminal 12 and the locking lance 17 when the connector 10 is in a single state, it is desired to move the moving plate 13 at the initial position to the connection position in consideration of the operability of the unlocking jig 200.

In the case of this embodiment, a tip part of a jig 100 is inserted into the through hole 27 and hooked to the hooking portion 49 of the projecting portion 48 as shown in FIG. 12. By pulling the jig 100 rearward in that state, the moving plate 13 can be moved toward the connection position.

Since the locking projections 31 are in front of and adjacent to the hooking portion 49 of the projecting portion 48 when the moving plate 13 is at the initial position, a pulling force of the jig 100 can be directly transferred to the locking projections 31. Thus, the locking of the locking projections 31 and the plate body 33 can be easily released according to a rearward movement of the plate body 33. In this way, the moving plate 13 can be brought to the connection position.

As shown in FIG. 13, by inserting the unlocking jig 200 into the jig insertion hole 36 of the plate body 33 and the tip of the jig 200 is caused to act on the locking lance 17 when the moving plate 13 is at the connection position, the locking of the locking lance 17 to the locking claw 22 of the male terminal 12 can be released. By pulling the wire 20 rearward with the locking of the locking lance 17 released, the male terminal 12 can be pulled out from the cavity 16.

As described above, according to this embodiment, a movement amount of the moving plate 13 from the connection position can be detected by a worker visually confirming the projection amount of the projecting portions 48 from the through holes 27. By visually confirming the states (postures) of the respective projecting portions 48, a positional relationship of the respective projecting portions 48 and a positional relationship of the respective projecting portions 48 and the housing 11, whether or not the moving plate 13 is inclined can be detected. Particularly, in the case of this embodiment, since the projecting portions 48 are maintained in a state unlocked to the housing 11 and do not interfere with the housing 11 and, in addition, the projecting portions 48 themselves have a simple strip plate-like shape, visibility is excellent. As a result, reliability in detecting the state of the moving plate 13 can be improved.

Further, since the hooking portions 49 (rear end parts) of the respective projecting portions 48 are arranged in the through holes 27 at the initial position, it is understood that the moving plate 13 is not arranged at the initial position in a state where the respective projecting portions 48 are exposed to outside.

Further, since the hooking portions 49 of the respective projecting portions 48 are arranged along the outer surface of the housing body 14 at the connection position, the projecting portions 48 are protected by the housing body 14 and the breakage and damage thereof can be avoided.

Furthermore, since the two projecting portions 48 are laterally arranged at an interval on the upper surface of the housing body 14, the state of the moving plate 13 can be more accurately detected based on the positional relationship of the respective projecting portions 48 and the positional relationship of the respective projecting portions 48 and the housing 11. Further, even in a situation where one projecting portions 48, out of the two projecting portions 48, cannot be visually confirmed, the state of the moving plate 13 can be detected by looking at the other projecting portion 48.

Furthermore, by hooking the jig 100 to the hooking portion 49 of the projecting portion 48 and pulling the jig 100 rearward in pulling out the male terminal 12 from the cavity 16, the projecting portion 48 can be pulled out from the through hole 27 and the moving plate 13 can be brought to the connection position. According to this, a possibility that the jig 100 interferes with the tab 19 of the male terminal 12 is reduced unlike a case where the moving plate 13 is brought to the connection position by pushing the plate body 33 from front by the jig 100. Thus, the breakage and damage of the tab 19 can be prevented.

### Other Embodiments of Present Disclosure

The embodiment disclosed this time should be considered illustrative in all aspects, rather than restrictive.

In the case of the above embodiment, the plurality of projecting portions are provided on the moving plate. However, as another embodiment, only one projecting portion may be provided on the moving plate. This one projecting portion is desirably exposed on the upper surface of the housing body at least at the connection position in view of visibility.

In the case of the above embodiment, the rear end part of the projecting portion is arranged in the through hole at the initial position. However, as another embodiment, the rear end part of the projecting portion may be exposed rearward from the through hole at the initial position.

In the case of the above embodiment, the rear end part of the projecting portion is exposed to outside from the through hole in an initial stage of connection from the initial position toward the connection position. However, as another embodiment, the rear end part of the projecting portion may be exposed to outside from the through hole immediately before the connection position is reached.

In the case of the above embodiment, the projecting portion includes the hooking portion on the rear end part. However, as another embodiment, the projecting portion may not include the hooking portion. For example, the projecting portion may be a mere smooth flat plate.

In the case of the above embodiment, the projecting portions are arranged not to contact the outer surface (upper and lower surfaces) of the housing body when the moving plate moves between the initial position and the connection position. However, as another embodiment, the projecting portions may be in contact with the outer surface of the housing body, although not being locked to the outer surface, when the moving plate moves between the initial position and the connection position.

List of Reference Numerals

| | |
|---|---|
| 10 | connector |
| 11 | housing |
| 12 | male terminal |
| 13 | moving plate |
| 14 | housing body |
| 15 | receptacle |
| 16 | cavity |
| 17 | locking lance |
| 18 | body portion |
| 19 | tab |
| 20 | wire |
| 21 | barrel portion |
| 22 | locking claw |
| 23 | retainer |
| 24 | receptacle body |
| 25 | step portion |
| 26 | bulging portion |
| 27 | through hole |
| 28 | lock portion |
| 29 | resilient locking portion |
| 31 | locking projection |
| 32 | complete locking projection |
| 33 | plate body |
| 34 | positioning hole |
| 35 | tab guiding portion |
| 36 | jig insertion hole |
| 37 | jig guiding portion |
| 39 | large-size positioning hole |
| 42 | large-size jig insertion hole |
| 43 | engaging portion |
| 44 | engaging projection |
| 45 | guide portion |
| 46 | frame portion |
| 47 | locked portion |
| 48 | projecting portion |
| 49 | hooking portion |
| 90 | mating connector |
| 91 | mating housing |
| 92 | mating cavity |
| 93 | female terminal |
| 94 | lock arm |
| 95 | releasing portion |
| 96 | plate engaging portion |
| 100 | jig |
| 200 | unlocking jig |

1. A connector, comprising:
a housing including a receptacle;
a male terminal including a tab projecting into the receptacle; and
a moving plate arranged movably with respect to the housing between an initial position and a connection position rearward of the initial position in the receptacle,
the moving plate including a plate body for surrounding the tab of the male terminal in the receptacle and a projecting portion projecting rearward from the plate body,
the housing including a through hole, the projecting portion being passed through the through hole, and
the projecting portion being maintained in a state unlocked to the housing and a rear end part thereof being exposed rearward from the through hole at least at the connection position.

2. The connector of claim 1, wherein the rear end part of the projecting portion is arranged in the through hole at the initial position.

3. The connector of claim 1, wherein the housing includes a housing body behind the receptacle, the housing body accommodating the male terminal, and the rear end part of the projecting portion is arranged along an outer surface of the housing body at the connection position.

4. The connector of claim 1, wherein a plurality of the projecting portions are formed side by side behind the plate body.

5. The connector of claim 1, wherein the projecting portion includes a hooking portion projecting in a direction intersecting a front-rear direction from the rear end part of the projecting portion.

6. The connector of claim 5, wherein:
the housing includes a deflectable and deformable resilient locking portion projecting rearward, and
a rear end part of the resilient locking portion includes a locking projection adjacent to the hooking portion to lock the plate body when the moving plate is at the initial position.
